(19) United States
(12) Patent Application Publication
(10) Pub. No.: US 2017/0046500 A1
(43) Pub. Date: Feb. 16, 2017

(54) SYSTEM TO GIVE DOCTORS AND PATIENTS EASIER ACCESS TO EACH OTHER

(71) Applicant: Sleep Science Partners, Inc., Larkspur, CA (US)

(72) Inventor: Noel Lindsay, Ross, CA (US)

(21) Appl. No.: 15/295,925

(22) Filed: Oct. 17, 2016

Related U.S. Application Data
(63) Continuation-in-part of application No. 13/044,377, filed on Mar. 9, 2011.
Application No. 13/044,377 is a continuation-in-part of application No. 12/688,714, filed on Jan. 15, 2010.
(60) Provisional application No. 61/312,152, filed on Mar. 9, 2010.

(51) Int. Cl. G06F 19/00

(52) U.S. Cl. CPC G06F 19/3456; G06F 19/363

(57) ABSTRACT

Various exemplary systems and methods include a method for automatically generating a prescription for a prescription product based on a standing order. The standing order is used to determine whether an entirely new prescription for the prescription product will be issued to a user before the prescription product is filled or dispensed based on user response data from the user that is received independent of any prior contact with an authorized prescriber.

### CROSS-REFERENCE TO RELATED APPLICATIONS

The present application is a continuation-in-part and claims the priority benefit of U.S. patent application Ser. No. 13/044,377 filed on Mar. 9, 2011, titled “Issuing Prescriptions from Standing Orders,” which is hereby incorporated by reference in its entirety, which in turn is a continuation-in-part and claims the priority benefit of U.S. patent application Ser. No. 12/688,714 filed on Jan. 15, 2010, titled “Device for Automatically Issuing a Prescription for a Prescription Product,” which is hereby incorporated by reference in its entirety. The present application also claims the priority benefit of U.S. Provisional Patent Application Ser. No. 61/312,152 filed on Mar. 9, 2010, titled “Matching Patients with Healthcare Providers to Facilitate Prescriptions,” which is hereby incorporated by reference in its entirety.

### BACKGROUND

New physicians must find new patients to grow their practices and physicians with mature practices must replace patients who leave due to normal turnover. Most physicians are reluctant to advertise for this purpose so they typically rely on health insurance company referrals, word-of-mouth and online medical review websites. However when these mechanisms do not produce the needed flow of new patients, physicians may find themselves without enough patients to adequately support their practices.

Meanwhile many people lack a primary care physician. Even if they occasionally see specialists to address specific health problems, these people do not have a doctor who can treat routine health problems. As a result, many of these people ignore minor problems until they become more severe, often resulting in a trip to an urgent care center or even a hospital emergency department. Treating routine health matters in this way is not only costly and inconvenient for these patients, it is also costly for society as a whole. There are many reasons why so many patients fail to establish a relationship with a primary care physician, but for many, it's simply because they never get around to doing it.

Most of these routine health problems could easily have been diagnosed and treated by a physician by simply advising the patient on corrective steps or by prescribing treatment using a readily-available medication or medical device, and in many cases, the physician could even have rendered a diagnosis and prescribed treatment with just a phone call. However without a pre-existing relationship between the patient and the physician, this type of convenient, helpful interaction is rare.

Even though it is rare for a physician to interact with someone over the phone who is not already one of their patients, all physicians have the ability to prescribe specific treatment for anyone who meets specific prescribing criteria, even when they are not present. These criteria are specified in a “standing order.” Standing orders may also be issued by dentists and other healthcare professionals. They are common in hospital settings but they may be used anywhere.

### BRIEF SUMMARY OF THE INVENTION

Various exemplary systems and methods include a method for automatically generating a prescription for a prescription product based on a standing order. The standing order is used to determine whether an entirely new prescription for the prescription product will be issued to a user before the prescription product is filled or dispensed based on user response data from the user that is received independent of any prior contact with an authorized prescriber. The method includes receiving on a standing order server from the authorized prescriber the standing order for the prescription product, the standing order in effect until an expiration date and the standing order used to determine whether the entirely new prescription for the prescription product will be issued to a user before the prescription product is filled or dispensed based on user response data from the user that is received independent of any prior contact with the authorized prescriber, and receiving on the standing order server a user response to a computerized questionnaire, the computerized questionnaire based on questions about health conditions and symptoms, the user response including biometric data received from the user by the biometric input device. A processor executes instructions stored in memory to issue the entirely new prescription for the prescription product, the entirely new prescription issued if the prescription requirements in the standing order are satisfied and without the user visiting a healthcare professional to have the entirely new prescription issued, and executing by a processor instructions stored in memory to not issue the entirely new prescription for the prescription product if the set of prescription requirements in the standing order are not satisfied.

According to further exemplary systems and methods, the standing order server automatically transmits a standing order interface to the authorized prescriber, and the standing order server automatically electronically determines a presence of one or more networked biometric sensors and includes a selection of a value corresponding to each type of recognized networked biometric sensors or a value corresponding to an unrecognized networked biometric sensor. The value is available for use within the standing order interface that the authorized prescriber uses in generating the standing order and transmitting it to the standing order server. Additionally, the standing order server may automatically populate the standing order interface with prescribing information from a manufacturer of a prescription product that the authorized prescriber chooses from in generating the standing order and transmitting it to the standing order server. Additionally, the standing order interface may be displayed on a mobile device or via an interactive voice recognition system to the authorized prescriber.

Exemplary methods may further include aggregating on the standing order server a plurality of standing orders received from a plurality of authorized prescribers, and if the user response satisfies prescription requirements in the plurality of standing orders, the standing order server may transmit and display to the user the plurality of standing orders and information about the plurality of authorized prescribers associated with each of the standing orders. Such displaying may be within an application on a mobile device belonging to the user, and the mobile device may transmit a selection of one of the plurality of prescribers to the standing order server and the standing order server, in response, transmitting the entirely new prescription for the prescription product in machine readable form to the mobile device belonging to the user for displaying within the application.

The standing order server, according to various exemplary embodiments, may receive the user response to the computerized questionnaire from an application on a mobile device of the user, and the standing order server may receive a global position system (GPS) location from the mobile device of the user and automatically compare it to an address entry received on the standing order server as part of the user response to the computerized questionnaire. The user response to the computerized questionnaire from the application on the mobile device of the user may include a designation of a biometric device belonging to the user, and the user may download biometric data to the mobile device and the mobile device may transmit the biometric data to the standing order server. The standing order server may use the transmitted biometric data as part of the user response.

Further exemplary embodiments include forming a library of standing orders for a plurality of diseases, physical conditions or mental conditions. The displayed information about the plurality of authorized prescribers may include displaying a profile for each authorized prescriber, and the displayed profile may include displaying information about any of an accepted insurance provider, distance from the user, education, training, experience, the amount of any fee that will be charged including a fee accepted for each accepted form of insurance. Additionally, the displayed plurality of standing orders may offer the user choices of treatment options, therapies, accepted insurance plans, costs, fees, or treatment facilities.

### BRIEF DESCRIPTION OF THE DRAWINGS

FIG. 1 shows an exemplary architecture 100 for use of a standing order library for healthcare delivery.

FIG. 2 shows an exemplary method 200 for use of a standing order library for healthcare delivery.

FIG. 3 shows another exemplary method 300 for use of a standing order library for healthcare delivery.

### DETAILED DESCRIPTION

Embodiments of the present invention provide a novel and improved method and system through which physicians may define standing orders that may be used to conveniently prescribe treatment to people at times and places that are convenient for the people receiving this treatment but inconvenient for the physician prescribing the treatment. In this way, the people may become patients of doctors who may be seeking new patients while patients obtain convenient, cost-effective healthcare on a timely basis.

In addition to physicians defining and using standing orders in this way, other authorized prescribers may also do so, including dentists, nurse practitioners, physician assistants, and any other type of healthcare professional authorized to prescribe treatment under the laws of the local jurisdiction. Embodiments of the present invention apply equally to physicians and all other such authorized prescribers.

The present invention, according to various exemplary embodiments, allows physicians to securely access a “standing order server” for the purpose of creating and storing the desired standing orders which may then be securely accessed as needed to prescribe treatment when appropriate. In some embodiments, physicians would use a website, a computer application or other electronic means to access the standing order server. In other embodiments, physicians may interact with people who are expert at creating standing orders based on the criteria specified by the physicians, and storing the resulting standing orders in the standing order server on the physicians' behalf. Over time, this standing order server could eventually contain a very large number of standing orders covering a wide range of medical conditions from a wide variety of physicians and other authorized prescribers.

In some embodiments, physicians may also specify a professional fee associated with each standing order that they define. This professional fee would then be charged to any patients receiving a prescription pursuant to that particular standing order unless the physician agrees to accept a lower amount, as is typically the case when physicians contract with a particular health insurance company when treating their policyholders.

In some embodiments, physicians may also specify a list of contracted health insurance plans. For each such plan, physicians may further specify the contracted rates for each plan for each of the various procedures they may want to provide through their standing orders.

Prospective patients who wish to address health problems may then securely interact with a “prescription server” which would also securely interact with the standing order server and attempt to match each such prospective patient with a standing order that is relevant and appropriate to each prospective patient's needs. To obtain the information needed for this matching process, the prescription server would ask the prospective patient questions such as their place of residence, health insurance coverage, and symptoms. In some embodiments, the prescription server would also request and obtain information needed to establish the identity of the prospective patient but in other embodiments, the prospective patient may keep their identity secret and thereby remain anonymous.

This process of matching prospective patients with available standing orders would be based on a variety of criteria, such as the type of symptoms as described by the prospective patient; the geographic proximity of the prospective patient and the doctors who defined the various available standing orders; these doctors' willingness and ability to accept the health insurance coverage of the prospective patient; and criteria that the prospective patient may use to select a doctor based on their own particular preferences such as educational background, board certifications, research publications, language fluency, consumer reviews and ratings and any professional fee that the physician may have specified. In embodiments in which the prospective patient has disclosed his or her identity, this matching process may also include criteria that the doctors may use to filter out unacceptable prospective patients such as any known history of initiating legal malpractice lawsuits and creditworthiness.

If more than one available standing order is a match for a given prospective patient, a list of the physicians who specified the matching standing orders, or a subset thereof, may be presented to the prospective patient. The patient may filter the list by eliminating physicians who do not meet certain criteria, such as being contracted with their insurance plan. The sequence of the remaining physicians may be based on any of several available criteria. For example, some patients may prefer to sort the list based on geographic proximity while others may choose to sort it based on a particular consumer rating. The available physicians may also be displayed on a map, clearly showing their geographic locations. The prospective patient then selects a physician from the presented list, and in doing so, becomes the patient of the selected doctor, unless the selected physician has specified a professional fee for the relevant standing order, in which case the prospective patient will be informed of this fee and may be asked to pay it before becoming a patient.

In embodiments in which the prospective patient has maintained anonymity prior to this matching process, the prospective patient would be required to provide identifying information before becoming a patient.

Once a prospective patient has become the patient of the doctor who specified the selected standing order, information is gathered about the patient to determine if he or she meets the prescribing criteria defined in the standing order needed to receive a prescription for treatment. This information may include answers to additional questions that are asked of the patient as well as biometric data such as blood pressure, body temperature, electrocardiographic data, electroencephalographic data, imaging data and test results of bodily fluids such as blood and saliva.

Potential patient and patients may interact with the prescription server via a website, a computer or smart phone application, a kiosk, by talking by telephone or in person with someone who transcribes questions and answers, or by talking by telephone with an interactive voice response (IVR) system. Biometric data may be produced by devices that are known to be of adequate quality such as those attached to a known type of kiosk or by devices that may be obtained by consumers which are known to meet specific criteria such as specific brands and models of blood sugar monitors that are able to interface with computers or smart phones.

In some embodiments, the process of matching prospective patients with available standing orders may be made after the prescription server has already obtained all of the information needed to determine whether or not a particular patient can meet the prescribing criteria of the various standing orders that are available. In these embodiments, the prospective patient may be matched with one or more available standing orders based on the prospective patient's ability to meet the prescribing criteria specified in the available standing orders.

Patients who meet the prescribing criteria specified in the selected standing order are automatically issued prescriptions for the appropriate treatment.

Patients who do not meet these criteria, are not issued a prescription although feedback may be provided to the patient as specified in the standing order. For example, in some situations, patients may be advised to contact the physician's office to schedule an appointment for further evaluation, either in person, by telephone or by video call. In other situations, the patient may be advised that their condition may be serious and that they should seek immediate medical care in person.

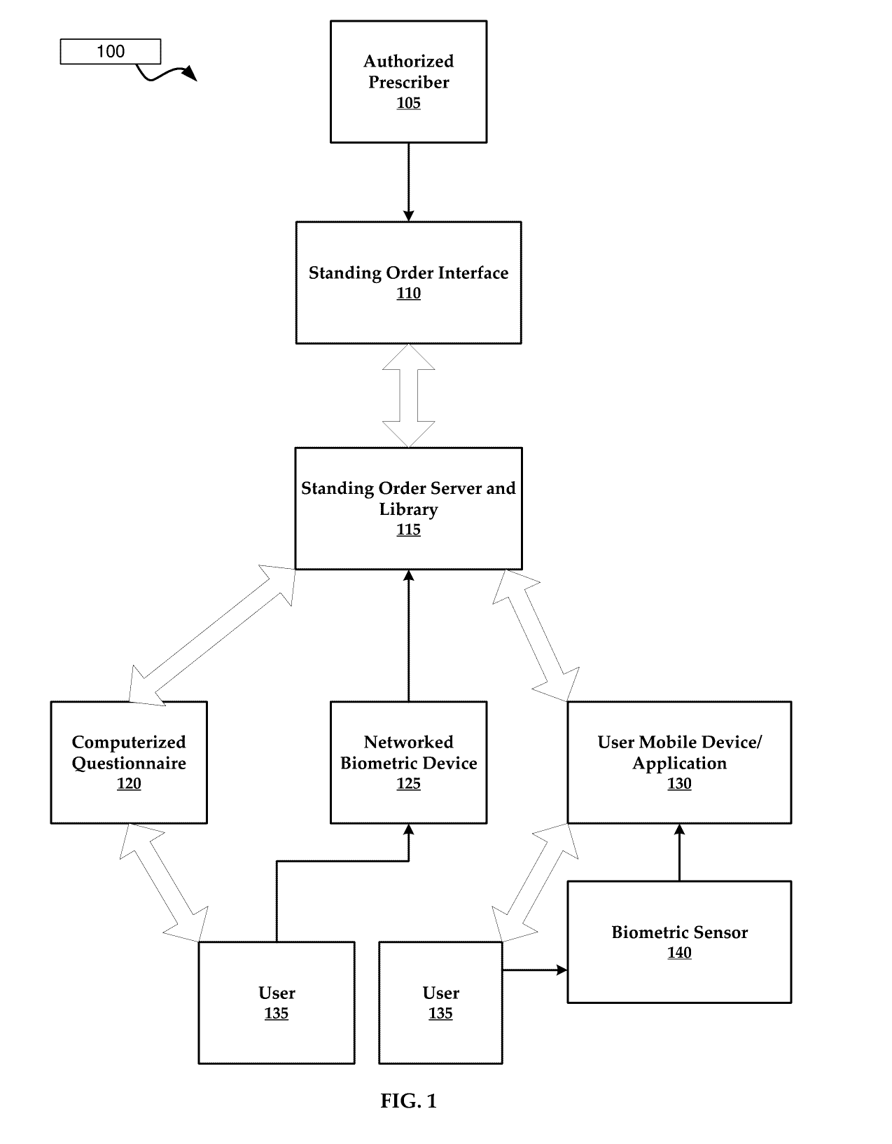

FIG. 1 shows an exemplary architecture 100 for use of a standing order library for healthcare delivery. Shown in FIG. 1 are an authorized prescriber 105, standing order interface 110, standing order server and library 115, computerized questionnaire 120, networked biometric device 125, user mobile device/application 130, users 135, and biometric sensor 140.

According to exemplary embodiments, the authorized prescriber 105 is any party legally authorized to treat medical and/or dental conditions. Standing order interface 110, according to most exemplary embodiments, resides in standing order server and library 115. Standing order interface 110 is the interface used by the authorized prescriber 105 to generate a standing order. The standing order interface 110, in some exemplary embodiments, may be in the form of a mobile application that interacts with the standing order server and library 115.

The standing order server and library 115, according to various exemplary embodiments, is the hub of the exemplary architecture 100. The library of standing orders in the server represent numerous standing orders for a variety of conditions. Based on user responses to questionnaires and the biometric data they provide, one or more standing orders from one or more authorized prescribers may be displayed to the user. This architecture results in the association of the user with a chosen prescriber and the delivery of an appropriate treatment to the user.

In various exemplary embodiments, the computerized questionnaire 120 resides in the standing order server and library 115 and is displayed to the user(s) 135 either through an interactive kiosk, the web, or through a mobile application such as user mobile device/application 130. The networked biometric device 125, according to various embodiments, may comprise a biometric device at a kiosk that provides user biometric data in connection with the user interacting with the computerized questionnaire 120.

The user mobile device/application 130, according to various exemplary embodiments, comprises an application on a mobile device communicatively coupled to the standing order server and library 115. The computerized questionnaire 120 or the equivalent may be part of the application. Additionally, the user mobile device/application 130 may be able to interact with an external biometric sensor, such as biometric sensor 140 with or without the involvement of the standing order server and library 115. In many exemplary embodiments, the user(s) 135 is anyone in need of medical or dental treatment or therapies, and in many cases, a skilled medical or dental provider.

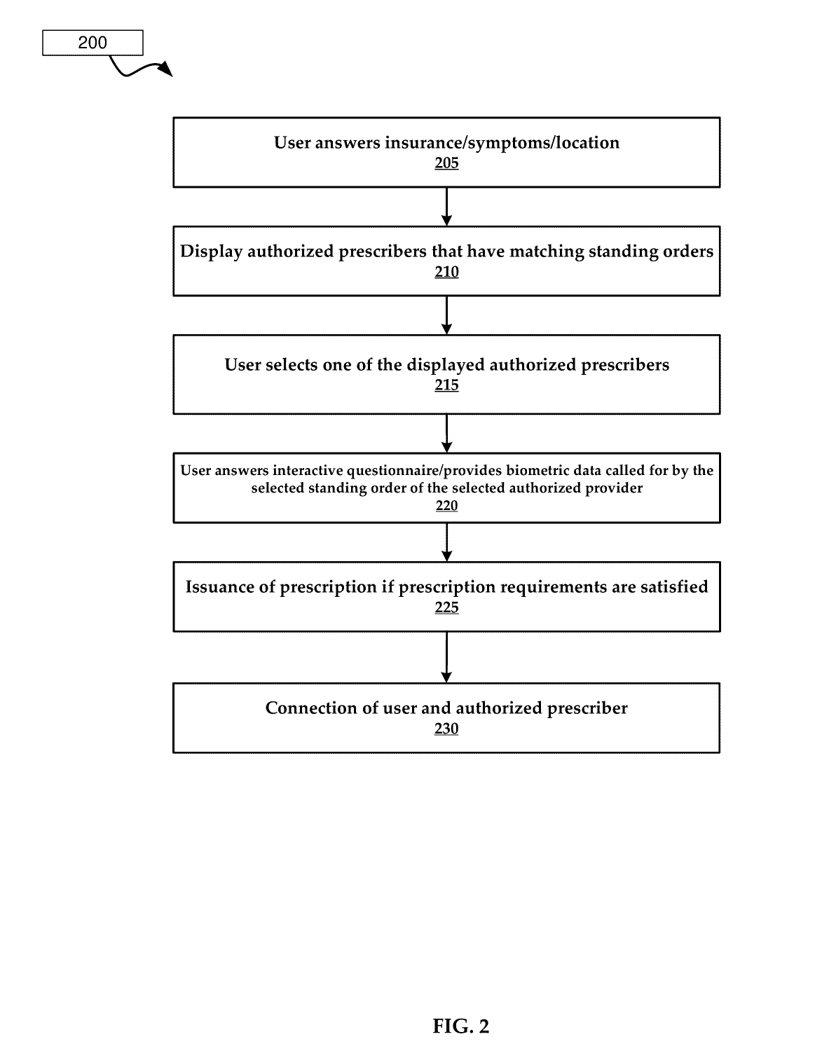

FIG. 2 shows an exemplary method 200 for use of a standing order library for healthcare delivery.

At step 205, a user answers insurance plan questions, provides symptom related information, and provides their geographical location.

At step 210, in response to the information provided at step 205, a display of authorized prescribers that have standing orders that satisfy the provided information is provided to the user.

At step 215, the user selects one of the displayed authorized prescribers.

At step 220, the user answers an interactive questionnaire and provides biometric data via a biometric device as specified by the prescription requirements of the authorized prescriber's standing order.

At step 225, a prescription associated with the standing order is issued to the user or transmitted to a pharmacy associated with the user if the prescription requirements are satisfied.

At step 230, the authorized provider that issued the standing order and the user established a connection.

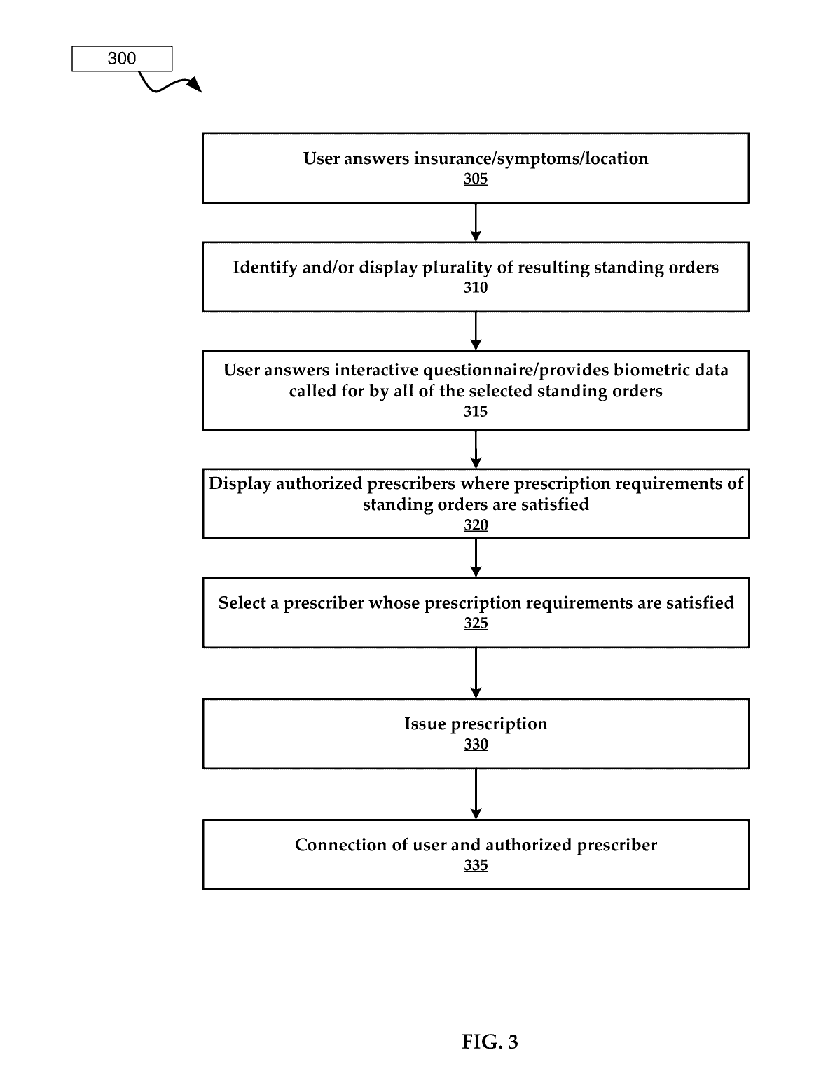

FIG. 3 shows another exemplary method 300 for use of a standing order library for healthcare delivery.

At step 305, a user answers insurance plan questions, provides symptom related information, and provides their geographical location.

At step 310, in response to the information provided at step 305, standing orders that satisfy the provided information are identified.

At step 315, the user answers the interactive questionnaire and provides biometric data as required by the prescription requirements of all of the identified standing orders.

At step 320, authorized prescribers whose standing order prescription requirements were satisfied are displayed.

At step 325, the user selects a prescriber whose prescription requirements were satisfied.

At step 330, a prescription associated with the standing order is issued to the user or transmitted to a pharmacy associated with the user.

At step 335, the authorized provider that issued the standing order and the user established a connection.

Methods 200 and 300 vary, as Method 200 limits the ability of a desperate user (e.g. addict) to find an authorized prescriber that would be willing to write a prescription. In contrast, Method 300 provides this ability, as this capability may be legitimately useful in certain situations.

The standing orders, according to exemplary embodiments, represent rules as defined by each healthcare provider (i.e. each authorized prescriber) that the user's answers and biometric data must satisfy for a prescription to be issued to the user in the healthcare provider's name. Additionally, a standing order for a particular healthcare provider may include several treatment options for the user. Furthermore, each of the healthcare providers may be associated with a profile which contains information about that particular healthcare provider including the distance of the healthcare provider's office from the user and other information that would be important to users when selecting a healthcare provider.

### Example 1

As an example, an obese man walks into a pharmacy and sees a display for the prescription pharmaceutical, Contrave (naltrexone hydrochloride). This in-store display makes the compelling argument that this medication could help him to finally lose weight after years of unsuccessful efforts. The man does not have a primary care physician but notices that the in-store display invites people to a kiosk in the back of the store where they may be able to obtain a prescription for Contrave. So the man goes to the back of the store and finds the kiosk.

Prior to this time, a number of primary care physicians in the local area have defined profiles for themselves which are stored in a “standing order server.” Each physician's profile includes the addresses, phone numbers and fax numbers for each location of their practice; information on his or her medical education, internships, residencies, and board certifications; any research papers they've published and any awards they've received. Each profile would also include a list of their contracted health insurance plans as well as each plan's contracted rate for each procedure for which the physician may want to bill patients.

These physicians also defined various standing orders for various types of medications and medical devices to treat various health conditions and these standing orders are also stored on the standing order server. Several of them have defined standing orders for prescribing Contrave and other similar medications used to treat obesity and these standing orders are now stored in a server that is operated by the company that also operates the in-store kiosk. Each such physician creates his or her standing order based on known prescribing guidelines from the manufacturer as well as his or her own professional judgment and experience. For example, a physician's standing order may define criteria that are more stringent than he or she would use if personally examining a patient. Each such doctor also specifies the dosage and instructions for use of any treatment specified in his or her standing orders. Each such physician also provides the fee that they charge, if any, for their standing order to be used and to provide appropriate follow-up.

The man in the pharmacy begins to interact with the kiosk. It queries him to determine what type of health condition he would like to address and he indicates that he would like help in losing weight. It then asks the man to select his health insurance policy, if any, from a series of pull-down menus and to enter the zip code where he lives. After the man provides this information, the kiosk queries the standing order server using an encrypted or otherwise secure connection. This query of the standing order server returns several standing orders which seem to be a good match for the patient. The physicians who defined these standing orders are presented in a list to the patient.

The list includes the names of the physicians as well as a variety of information about each one, specifically, whether or not the physician is contracted with the patient's health insurance plan, board certifications, medical education, consumer reviews and the amount of any professional fee that the physician charges to use his or her services through the kiosk. Those physicians who are contracted with the prospective patient's health insurance provider are indicated, with the note that those physicians will accept the amount paid by the man's health insurance. For those physicians who created profiles which specified the contracted rate for the relevant medical procedure for the prospective patient's insurance plan, this contracted rate will be the fee that is displayed. The man may sort this list by any of these parameters and even view the list in the form of a map, showing the geographical location of the physicians.

The man selects one of the physicians from the list who accepts his health insurance and who seems to have impressive credentials and favorable reviews from past patients. Since this physician is contracted with the man's health insurance provider, the man is asked to confirm that he will pay the portion of the contracted rate due from him, once the health insurance company pays its share. The man agrees and swipes his credit card which will be debited once the amount of this coinsurance is known. He also enters his name, address, phone number, e-mail address and date of birth. The man is now a patient of the physician who defined the selected standing order.

The patient is then asked additional questions, as needed, to determine if the patient meets the criteria specified in the selected standing order, starting with the indications and contraindications for this medication.

The patient is asked to enter his age, gender, height and weight, from which his body mass index is calculated. In this particular case, it is 33 kg/m̂2 which satisfies the indications for use for Contrave. The patient is then asked if he has a history of seizures or has forced himself to vomit after meals, even just occasionally, as these are contraindications of Contrave. The man confirms that neither is the case so he is then asked if he is using any of several other medications that could interfere with Contrave, and after reviewing the list, he confirms that he is taking none of them. The patient is then asked if he has used any opiates in the last thirty days and a list of possible opiates is displayed. He indicates that he recently used hydrocodone, so he is asked to select the dosage, the most recent usage, how often he takes this medication and for how long. The patient uses pull-down menus to provide this information. Because he only used a relatively low dosage of hydrocodone for less than a week and that his usage ended over two weeks ago, he satisfies the criteria specified in the prescribing physician's standing order. The patient is then asked if he knows of any allergy to bupropion or naltrexone. Since the patient has never even heard of these medications, he knows that he is not aware of any allergy to them. The patient is then asked to quantify the amount of alcohol he consumes. He indicates that he typically has two to three drinks per day which meets the relevant criterion in the selected standing order. Finally the standing order requires that the patient not be pregnant, and since the patient has already indicated that he is male, the patient has now satisfied all of the prescribing criteria in the selected standing order except one. It also requires that the patient's blood pressure be within specific limits. To determine if this is the case, the patient is asked to insert his arm into the blood pressure cuff attached to the kiosk. He does so, his blood pressure is measured, and in this example, the patient's blood pressure is within the required limits.

The patient has now met all of the requirements specified in the selected standing order's prescribing criteria. Therefore the patient is informed that he is receiving a prescription for a particular type of treatment, in this case, Contrave. However it should be noted that if the patient had answered questions differently throughout this process, he may have been prescribed a different treatment or no treatment at all. The kiosk will provide the patient with the name, address and phone number of the prescribing physician and will inform the patient of proper dosage, instructions, risk factors and potential side-effects. In particular, it warns him to discontinue use and to call the prescribing doctor if he begins to have any suicidal thoughts. This is a known risk factor for Contrave but only for people under the age of twenty-four. For this reason, the physician who specified this standing order included a criterion that required the patient to be above this age. However in this case, the patient was forty-four so this was not an issue. It will also advise the patient to call the prescribing physician's office the following morning. The patient will be given the option to print this information or to receive it via e-mail or both. In this case, the patient elects to have this information e-mailed.

The patient will also be given the option to receive a printed prescription or to have it sent electronically to a pharmacy. In this example, the patient elects to have it sent electronically to the pharmacy in the same store where he and the kiosk are located. He is then advised that his prescription should be available for pick-up within fifteen minutes. So the patient continues his shopping and takes the items he wishes to buy to the pharmacy counter where he pays for them while also filling his prescription for Contrave.

The prescribing physician is notified of his or her new patient and is provided with all available information pertaining to the new patient. By the end of the following day, their office has not received a phone call from the new patient so someone from the office calls the patient and leaves a voicemail message, asking the patient to give them a call. The following day, the patient calls the office at which point it becomes clear to the medical assistant making the call that the patient has a good understanding of the new medication and its proper use. In this example, the patient is also advised to schedule an appointment to see the doctor in person but the patient declines, so in the subsequent days, the doctor calls the patient by phone to personally discuss his obesity and how best to address this condition, in addition to proper use of the prescribed medication. Over the subsequent months, the physician's office contacts the patient periodically, and eventually, the patient begins to schedule annual check-ups with the physician who then provides ongoing healthcare to the patient.

### Example 2

As another example, a diabetic woman moves to a new city and does not yet have a primary care physician or an endocrinologist. For years, she has successfully controlled her blood sugar through diet, exercise and the medication, Glucophage, without the need for insulin. However over the last few months, she has noticed that her blood sugar has been less stable so she wondered if she should switch to one of the newer medications.

To explore this possibility, she downloads an app on her smart phone which provides information about a wide variety of medications. She searches on diabetes and is provided with a list of medications used to treat this disease. The app also invites her to find out if any of these new medications would be medically appropriate for her and is told that, if this is the case, a prescription will immediately be issued for her and that she may use this prescription to purchase the prescribed medication online such that it would then be mailed to her.

She finds this offer to be extremely compelling because it is so convenient and she is extremely busy with her new job and getting settled into her new home. So she presses the button on the smart phone to initiate this process. The app asks permission to obtain her GPS location from her smart phone and her name, address, credit card and other personal information that is already stored in her smart phone for engaging in electronic commerce transactions. She gives her permission for this information to be disclosed and agrees to the terms and conditions which include an informed consent that pertains to the secure transmission of medical information and liability limits.

The smart phone app uses a convenient menu-driven interface that makes it easy and convenient for the woman to provide her health insurance information. The app also discovers her current location from the smart phone's GPS and uses all of this information to search a standing order server which contains many standing orders. Over a dozen standing orders are found that pertain to the woman's concerns which were defined by physicians in her local area who are contracted with her health insurance plan. In this particular case, all of these physicians are endocrinologists.

Each of the physicians who defined these standing orders also defined profiles that are also stored on the standing order server. The information in these profiles help prospective patients make informed decisions when choosing a physician such as the address and phone number of each of their office locations; medical education, including residency internships, specialties and board certifications; research publications; professional awards; consumer reviews and fees they charge. In addition to their normal fees charged for each common type of procedure, these profiles also include the contracted rates for each contracted health insurance plan.

The woman is presented with a list of the physicians who defined the standing orders matching her needs. The smart phone app allows her to easily filter and sort these physicians based on any criteria she likes, including the ability to display their locations on a map and to filter out those physicians who are outside of a selected area that she can define on the map. After being presented with all of this information, she selects the physician she thinks is the best fit for her needs. Using these tools, the process of picking a new endocrinologist was far easier than in had been for her in the past.

The selected endocrinologist defined a standing order in which he specifies prescribing criteria for his three favorite medications to control Type 2 diabetes, including Januvia, Victoza, and Invokana. Based on how each patient fits the criteria that he has defined, only one of these three medications may be prescribed to each patient, or if the criteria are not met for any of the three medications, no medication is prescribed. The smart phone app asks the woman questions about her medical history, symptoms, other medications she's currently taking, and allergies and she answers the questions.

Based on the way the woman has answered these questions, the standing order specifies that she will be prescribed Januvia unless the patient uses any of several acceptable blood glucose monitors that have the capability to upload data to the smart phone. If the patient has one of these specific monitors and uses it to upload data corresponding to historical blood glucose measurements, and if these measurements fit certain specific criteria, the standing order specifies that the patient should be prescribed Victoza instead of Januvia. In this particular case, the woman does use one of the known, acceptable blood glucose monitors and uploads two years' worth of measurement data to her smart phone. The smart phone app performs a statistical analysis of this data and determines that the blood glucose level has been too volatile to prescribe Januvia so Victoza is prescribed instead.

The maker of the smart phone app has a partnership with a legitimate online pharmacy that is licensed to dispense prescription medications to patients within the state where the woman resides so it asks the woman if she would like to purchase Victoza through this online pharmacy partner. The woman agrees so the endocrinologist's prescription for Victoza is electronically transmitted to the online pharmacy partner, along with the woman's name, address, date of birth, credit card information and health insurance information. Upon receipt of this information by the online pharmacy partner, the prescription is filled and the Victoza is mailed to the woman.

The woman and her new endocrinologist are each provided with information about the other. Since the smart phone app is integrated with the endocrinologist's patient scheduling software, the woman is even able to schedule her first appointment using her smart phone.

Through the use of this method, the woman was able to conveniently make an informed decision on her new endocrinologist while obtaining a new medication that is a better fit for her needs in a timely manner. At the same time, the endocrinologist obtains a new patient.

What is claimed:

1. A method for automatically generating a prescription for a prescription product based on a standing order used to determine whether an entirely new prescription for the prescription product will be issued to a user before the prescription product is filled or dispensed based on user response data from the user that is received independent of any prior contact with an authorized prescriber, the method comprising:
receiving on a standing order server from the authorized prescriber the standing order for the prescription product, the standing order in effect until an expiration date and the standing order used to determine whether the entirely new prescription for the prescription product will be issued to a user before the prescription product is filled or dispensed based on user response data from the user that is received independent of any prior contact with the authorized prescriber;
receiving on the standing order server a user response to a computerized questionnaire, the computerized questionnaire based on questions about health conditions and symptoms, the user response including biometric data received from the user by the biometric input device;
executing by a processor instructions stored in memory to issue the entirely new prescription for the prescription product, the entirely new prescription issued if the prescription requirements in the standing order are satisfied and without the user visiting a healthcare professional to have the entirely new prescription issued, and executing by a processor instructions stored in memory to not issue the entirely new prescription for the prescription product if the set of prescription requirements in the standing order are not satisfied.

2. The method of claim 1, further comprising the standing order server automatically transmitting a standing order interface to the authorized prescriber.

3. The method of claim 2, further comprising the standing order server automatically electronically determining a presence of one or more networked biometric sensors and including a selection of a value corresponding to each type of recognized networked biometric sensors or a value corresponding to an unrecognized networked biometric sensor, the value being available for use within the standing order interface that the authorized prescriber uses in generating the standing order and transmitting it to the standing order server.

4. The method of claim 2, further comprising the standing order server automatically populating the standing order interface with prescribing information from a manufacturer of a prescription product that the authorized prescriber chooses from in generating the standing order and transmitting it to the standing order server.

5. The method of claim 2, further comprising displaying the standing order interface on a mobile device or via an interactive voice recognition system to the authorized prescriber.

6. The method of claim 1, further comprising aggregating on the standing order server a plurality of standing orders received from a plurality of authorized prescribers.

7. The method of claim 6, further comprising if the user response satisfies prescription requirements in the plurality of standing orders, the standing order server transmitting and displaying to the user the plurality of standing orders and information about the plurality of authorized prescribers associated with each of the standing orders.

8. The method of claim 7, the displaying within an application on a mobile device belonging to the user.

9. The method of claim 7, further comprising the mobile device transmitting a selection of one of the plurality of prescribers to the standing order server and the standing order server, in response, transmitting the entirely new prescription for the prescription product in machine readable form to the mobile device belonging to the user for displaying within the application if the prescription requirements of the selected standing order are satisfied by the user.

10. The method of claim 1, the standing order server receiving the user response to the computerized questionnaire from an application on a mobile device of the user.

11. The method of claim 11, further comprising the standing order server receiving a global position system (GPS) location from the mobile device of the user and automatically comparing it to an address entry received on the standing order server as part of the user response to the computerized questionnaire.

12. The method of claim 10, the user response to the computerized questionnaire from the application on the mobile device of the user including a designation of a biometric device belonging to the user.

13. The method of claim 12, further comprising the user downloading biometric data to the mobile device and the mobile device transmitting the biometric data to the standing order server.

14. The method of claim 13, further comprising the standing order server using the transmitted biometric data as part of the user response.

15. The method of claim 6, further comprising the aggregating on the standing order server of the plurality of standing orders received from the plurality of authorized prescribers forming a library of standing orders for a plurality of diseases, physical conditions or mental conditions.

16. The method of claim 7, further comprising the displayed information about the plurality of authorized prescribers including displaying a profile for each authorized prescriber.

17. The method of claim 16, the displayed profile including displaying information about any of an accepted insurance provider, distance from the user, education, training, experience, the amount of any fee that will be charged including a fee accepted for each accepted form of insurance.

18. The method of claim 7, the displayed plurality of standing orders offering the user choices of treatment options, therapies, accepted insurance plans, costs, fees, or treatment facilities.
